(19) United States
(12) Patent Application Publication
(10) Pub. No.: US 2003/0024386 A1
(43) Pub. Date: Feb. 6, 2003

(54) Resilient element for a piston head

(76) Inventor: Walter T. Burke, Houston, TX (US)

Correspondence Address: AKIN, GUMP, STRAUSS, HAUER & FELD, L.L.P., 711 Louisiana, Suite 1900 South, Houston, TX, 77002, US

(21) Appl. No.: 09/921,170

(22) Filed: Aug. 2, 2001

(51) Int. Cl. F16J 9/00

(52) U.S. Cl. 92/240

(57) ABSTRACT

A reciprocating pump or compressor has a piston head assembly in a cylinder having an inside surface. The piston head assembly has a piston hub and a piston seal. The piston hub has a flange. A piston seal formed of a first and a second resilient material, the second resilient material having a hardness less than the hardness of the first resilient material, is mounted on the piston hub. The first resilient material abuts the flange and covers an outer surface of the flange. The second resilient material is bonded to the first resilient material. The piston seal has an annular bulge in the second resilient material with a maximum diameter interior to the annular bulge larger than the diameter of the inside surface of the cylinder, forming a seal with the cylinder when compressed upon insertion of the piston head assembly into the cylinder.

### CROSS-REFERENCE TO RELATED APPLICATIONS

Not applicable.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention relates generally to piston seals for reciprocating pumps and compressors and more particularly to a replaceable durable polymeric piston seal.

2. Description of the Related Art

Reciprocating pumps and compressors, such as mud pumps, are frequently used in the oil well drilling industry. Such pumps are commonly used for pumping drilling mud and other fluids in connection with oil well drilling operations. Because of the need to pump the fluids through several thousand feet of drill pipe, such pumps typically operate at high pressures. Moreover, it is necessary for the fluid to emerge from the drill bit downhole at a relatively high velocity in order to provide lubrication and cooling to the bit and to provide a vehicle for the removal of drill cuttings from the earth formation being drilled. Lastly, the pressure generated by the pump contributes to the total downhole pressure, which is used to prevent well blowouts.

The pistons and cylinders used for such reciprocating pumps are susceptible to a high degree of wear during use because the drilling mud is relatively dense and has a high proportion of suspended abrasive solids. As the pump cylinder becomes worn, the small annular space between the piston and the cylinder wall increases substantially and sometimes irregularly. For these reasons, the seal design for such pumps is critical.

The high-pressure abrasive environment in which the pumps must operate is especially deleterious to the seals since considerable friction forces are generated, and since the hydraulic pressures encountered during operation force the seal into the annular space between the cylinder wall and the piston. In some instances, the frictional forces may even detach the seal from the piston. In these instances, the edges of the seal can become damaged very quickly by the cutting or tearing action that occurs as a result of piston movement. Another problem with conventional mud pump seals is that they do not adequately “wipe” the cylinder wall, with the result that pressurized drilling mud seeps between the seal and the cylinder wall. Attempts have been made to retain the seal in the piston so as to resist this frictional force.

Conventional resilient piston seals produce the highest stress at their heel, where the resilient material is compressed against a metal piston hub and forced into the annular gap between the cylinder and the piston hub by high-pressure deformation. Such deformation produces wear, resulting in a shortened piston seal life. Other components of the pumps, such as cylinder liners, are damaged when a piston seal fails. Therefore, improving the life of a piston seal can reduce costs to an operator beyond the lowered costs for piston seal replacement.

Further, conventional reciprocating pumps use a piston head with a metal piston hub and a piston seal mounted on the piston hub. Metal-to-metal contact between the piston hub and the pump cylinder liner can also abrade and degrade the cylinder liner. Cylinder liners are typically manufactured with a high hardness, to minimize the damage caused by metal-to-metal abrasion. Some conventional cylinder liners have been manufactured using ceramic materials to attempt to achieve even higher hardnesses and abrasion resistance. However, these cylinder liners are expensive and costly to replace. Further, even the highest hardness cylinder liner can be abraded by contact with a metal piston hub.

Pumps using conventional piston seals have been forced to use lower pressures than desirable in order to achieve an acceptable piston seal life. Use of higher pressures would be desirable if lengthening the piston seal life could reduce the costs of replacing piston heads.

The nature of the reciprocating pump operating environment makes it difficult to effectively address these issues. It is, therefore, desired to develop a new and improved replaceable seal for a reciprocating pump piston head that overcomes the foregoing difficulties while providing better wear properties and more advantageous overall results.

### SUMMARY OF THE INVENTION

A reciprocating pump or compressor has a piston head assembly with a piston hub and a resilient piston seal that provides improved wear characteristics over conventional piston seals. The piston seal is mounted on a piston hub forming a piston head. The piston seal has a heel section of a first resilient material. The first resilient material of the heel section extends along an outer surface of the piston hub, covering a portion of the outer surface. In one embodiment, the entire outer surface is covered.

In one embodiment, the piston seal is bonded to the piston hub. In one embodiment a lip of the piston hub is overlapped with the first resilient material.

In a further embodiment, a lip section of a second resilient material, with the second resilient material being softer than the first resilient material. An annular bulge or projection in the lip section is compressible to form a seal when the piston head assembly is inserted into a cylinder with a smaller inside diameter than a diameter of the annular bulge, causing a constant seal in the liner at all times.

In a disclosed embodiment, the first and second resilient materials are polyurethane.

The annular bulge is machined into the lip section in one embodiment. In another embodiment, the annular bulge is molded into the lip section. In one embodiment, the annular bulge has a generally triangular cross section.

In one embodiment, a piston head assembly has two piston seals mounted on both sides of a piston hub for use in a duplex piston head assembly, with the piston hub being covered by the first resilient material, connecting heel sections of the two piston seals.

In another embodiment, a bumper section of the first resilient material is inserted at an intersection between the outer surface and a posterior surface of the piston hub.

### BRIEF DESCRIPTION OF THE DRAWINGS

A better understanding of the present invention can be obtained when the following detailed description of the preferred embodiment is considered in conjunction with the following drawings, in which:

FIG. 1 is a side view in partial cross section of a reciprocating pump;

FIG. 2 is a cross-sectional view of a conventional piston head assembly in a cylinder;

FIG. 3 is a cross-sectional view of a piston seal constructed in accordance with one embodiment;

FIG. 4 is a cross-sectional view of a second embodiment of a piston seal mounted on a piston hub in a cylinder;

FIG. 5a is a cross-sectional view of a third embodiment of a piston seal mounted on a piston hub;

FIG. 5b is an end view of the piston hub of FIG. 5a;

FIG. 6 is a cross-sectional view of a duplex piston head assembly;

FIG. 7a is a cross-sectional view of a fourth embodiment of a piston seal mounted on a piston hub in a cylinder;

FIG. 7b is a cross-sectional view of an alternate version of the piston seal of FIG. 7a; and

FIG. 8 is a cross-sectional view of a fifth embodiment of a piston seal mounted on a piston hub in a cylinder.

### DETAILED DESCRIPTION OF THE INVENTION

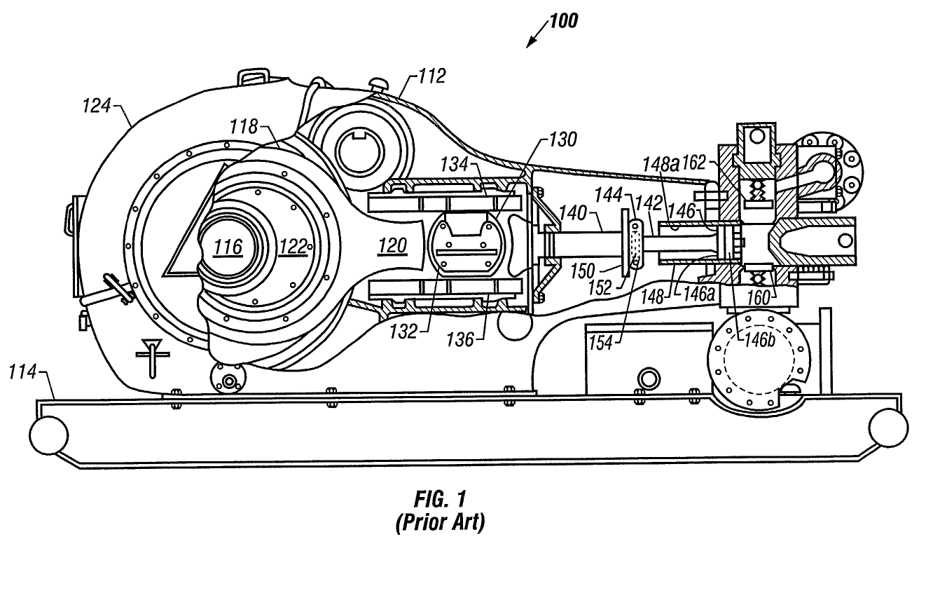

With reference to FIG. 1, a typical reciprocating pump that is representative of the prior art is generally designated as 100 and preferably includes the apparatus of FIG. 1, but is not limited thereto. A housing 112 is mounted on a frame 114. A driver (not shown), such as a diesel engine, is operatively connected to a crankshaft 116 for providing a rotative driving force. A crank 118 is connected to crankshaft 116, and a connecting rod 120 reciprocates in a known manner as crankshaft 116 rotates. Alternatively, direct reciprocation can be used instead of using crankshaft 116 and crank 118, such as provided by a hydraulic cylinder or other suitable means.

In general, a gear end 122 converts rotating motion into reciprocating motion. A cover 124 can be opened for providing access to gear end 122. A crosshead 130 is connected to connecting rod 120 by a crosshead pin 132. An upper crosshead shoe 134 and a lower crosshead shoe 136 slide in reciprocating motion. A crosshead extension rod 140 is connected to crosshead 130, and a piston rod 142 is connected to crosshead extension rod 140 by a clamp 144.

In a piston 145, a piston head 146 reciprocates within a piston cylinder 148 and is connected to piston rod 142. Piston cylinder 148 typically has a liner, which is not shown. A baffle 150 surrounds crosshead extension rod 140. Crosshead extension rod 140 has a flanged end 152, and piston rod 142 has a flanged end 154. Flanged ends 152 and 154 are shown connected together within clamp 144. Clamp 144 clamps around flanged ends 152 and 154, holding piston rod 142 in axial alignment with crosshead extension rod 140.

A suction valve assembly 160 opens and closes in coordination with the reciprocation of piston head 146 so that fluid is drawn into piston cylinder 148 as piston head 146 retracts to the left as viewed in FIG. 1. Pump 100 is shown in FIG. 1 as completing a pumping stroke, in which suction valve assembly 160 is closed, and a discharge valve assembly 162 is open. Discharge valve assembly 162 closes, and piston head 146 begins to retract, while suction valve assembly 160 begins to open.

Thus, reciprocation of piston head 146 within piston cylinder 148 provides a pumping action for discharging fluid through discharge valve assembly 162. Typically, a charge pump (not shown) is used for pumping fluid into piston cylinder 148 while suction valve assembly 160 is open. Consequently, it is not necessary for a strong suction to be developed within piston cylinder 148 by piston head 146 to charge the cylinder.

As shown in FIG. 1, the pump 100 uses a simplex piston head assembly, with a single piston seal mounted on each piston hub. Duplex piston head assemblies (not shown) are also used, with a piston seal mounted on both sides of a duplex piston hub.

Pump 100 or known alternative pumps can be used for pumping drilling fluid into an oil or gas well during drilling operations. When wells are drilled into the earth, a drilling fluid known as drilling mud is used to carry away cuttings from the drill bit. Several piston cylinders and piston heads comparable to piston cylinder 148 and piston head 146 operate cooperatively within pump 110 to pump drilling fluid down into the oil well, where cuttings are picked up and circulated back to the surface. The cuttings are cleaned out of the clean drilling fluid, and the drilling fluid is recirculated down into the hole by pump 110.

Pump 100 is typically a massive piece of equipment that operates continuously. Components wear out, and pump 110 must be taken out of service for repairs and maintenance. Repairs and maintenance are costly due to lost production time, as well as from the cost of labor and parts.

Typically, piston head 146 includes a metal piston hub 146a and a rubber piston seal assembly 146b. There is typically a gap between metal piston hub 146a and an inside wall 148a of piston cylinder 148 of about 0.005 inches.

Misalignment among these various components causes wear on inside wall 148a as metal piston hub 146a rubs and scars inside wall 148a. Further, such misalignment causes premature wear on crankshaft 116, crank 118, connecting rod 120, gear end 122, crosshead 130 and crosshead pin 132. For example, if a conventional piston rod is not aligned within a conventional piston cylinder, then the longitudinal axis of piston rod does not coincide with the longitudinal axis of the piston cylinder, which can cause the piston hub to rub the inside wall of the piston cylinder. The inside wall of the piston cylinder, the piston hub, and a rubber seal on the piston hub become worn as the piston hub rubs against the inside wall of the piston cylinder.

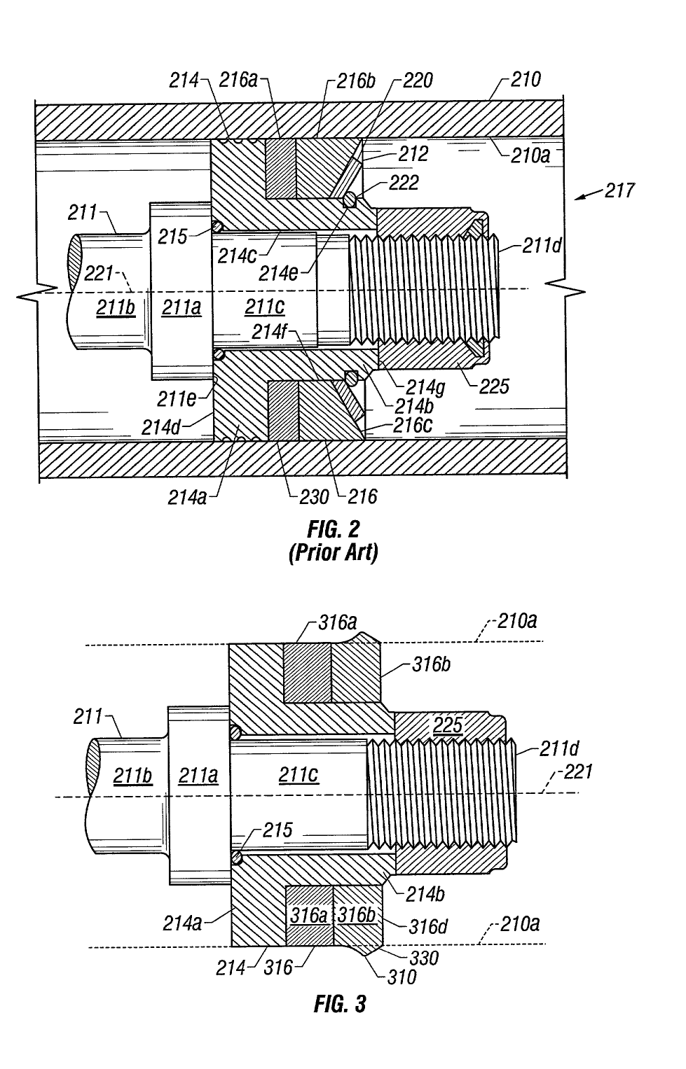

FIG. 2 depicts a prior art piston rod assembly for a piston driven pump such as is shown in FIG. 1. The pump housing is represented by the cylindrical wall generally designated as 210 having an internal cylindrical bore 210a. A replaceable liner (not shown) is typically used to form the cylindrical wall 210 to increase pump life, but is omitted from the drawings and the discussion for simplicity of the description. A piston rod generally designated as 211 includes the piston rod end section generally designated as 212. The piston rod end section includes a mounting base generally designated as 211a, which is formed with the main piston rod 211b and includes an annular mounting shoulder 211e. The piston rod end section 212 further includes a first rod section 211c generally cylindrical in configuration and machined to a diameter slightly less than the diameter of main rod portion 11b. The outer rod end section 211d is formed with a threaded end portion.

In order to mount a piston sealing assembly onto the end of the piston rod 211 of FIG. 2, it is known to use a mounting hub 214 which includes an annular base or flanged section 214a having a diameter substantially equal to the diameter of the internal cylinder wall bore 210a. The mounting hub 214 further includes a central hub section or shank 214b formed integrally with the annular base 214a and having an outside diameter approximately equal to the diameter of the piston rod mounting base 211a. The hub base 214a and central section 214b are formed integrally and have an internal opening or bore 214c having a diameter only slightly greater than the diameter of the piston rod end section 211c. The hub 214 is adapted to be mounted over the piston rod end sections 211c and 211d such that the annular end face 214d engages annular shoulder 211e of the piston rod mounting base 211a. O-ring 215 is positioned in a groove in the hub base 214a in order to provide a seal between the piston rod 211c and the hub 214.

Continuing the description of the prior art of FIG. 2, a piston seal generally designated as 216 includes an annular heel section 216a preferably formed of a fibrous material and an annular lip section 216b formed of rubber for purposes of slidingly and sealingly engaging the interior bore wall 210a of the piston cylinder 210. Typically, the lip section 216b is made of rubber, such as Shore A 80 Durometer carboxilated nitrile rubber and the heel section 216a is made of a rubber-coated cotton. It is known to use polyurethane for both the heel section 216a and the lip section 216b. Since the piston rod 211 reciprocates within the bore wall 210a, it is necessary to hold the piston seal 216 against movement in the direction of arrow 217. This is accomplished by utilizing an angled retainer ring 220 which is formed of steel or other suitable metal and extends at an acute angle with respect to the central axis 221 of the piston rod 211. The end face 216c of the lip section 216b extends at an acute angle with respect to central rod axis 221 such that the angled retainer ring 220 is mounted onto the central portion 214b of the hub 214 at substantially the same angle in order to provide a full annular area for the retainer ring to bear against the lip section 216b. The retainer ring 220 includes a central opening having a diameter slightly smaller than the outer diameter of control hub portion 214b such that the ring 220 is driven into position. A snap ring 222 is driven into an annular groove 214e formed into an external surface of the shank 214b. Finally, a retainer nut 225 is threadedly mounted over piston rod end section 211d into engagement with the annular end face 214g of the shank 214b, thereby maintaining the hub 214 in position on the piston rod end section 212.

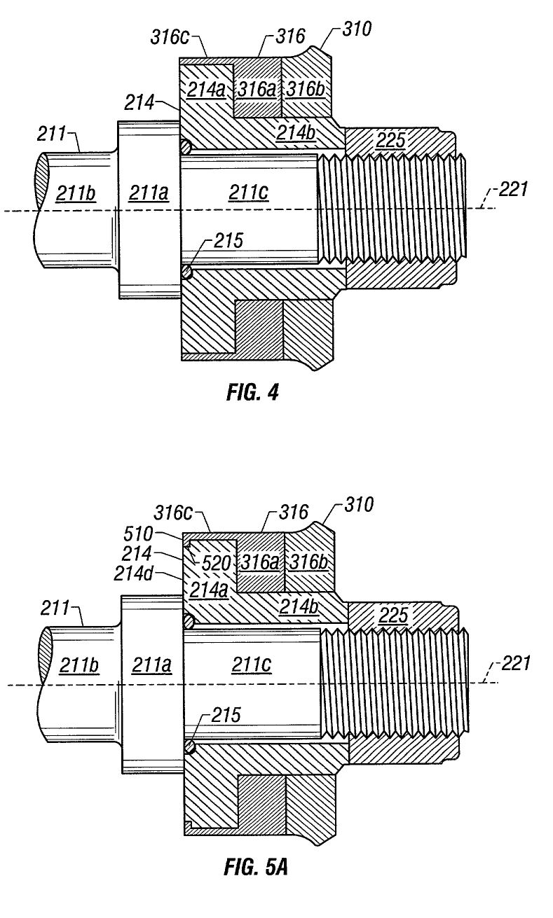

Referring now to FIGS. 3-5, the preferred embodiment of the invention will now be described in detail, with like numbers and letters utilized to identify the corresponding parts that are used in the prior art version of FIG. 2 of the piston end section 212, and with numbers in the 300 series to identify new or modified parts.

The heel section 316a of the piston seal 316 is generally annular about central axis 221, and is generally rectangular in cross-section as shown in the drawings. Lip section 316b is also generally annular about central axis 221. However, lip section 316b has an annular projection or bulge 310, with a maximum diameter larger than the diameter of the internal cylinder wall 210a.

In a conventional piston seal as in FIG. 2, pressure deformation occurs at a major stress point 230 where the piston seal heel section 216a abuts the flanged section 214a of the mounting hub 214. This pressure deformation causes premature wear of the piston seal 216.

In the present technique, the annular bulge or projection 310 transfers the stress point 330 forward to the softer resilient material that forms the lip section 316b. The annular bulge 310 is compressible upon insertion into the cylinder 210. By moving the stress point 330 to the annular bulge 310, wear on the piston seal 316 and the resultant shortened life of the piston seal 316 is reduced. Because the compressible annular bulge 310 has a diameter larger than the diameter of the bore 210a, wear on the annular bulge 310 will not destroy the seal, allowing longer life for the piston seal 316.

As shown in FIG. 3, one embodiment of the piston seal 316 has an annular bulge or projection 310 with a generally triangular cross-section. However, other cross-sectional shapes of the annular external projection or bulge 310 can be used.

The annular bulge 310 can be machined into the lip section 316b in one embodiment. In another embodiment, the lip section 316b is molded with the annular bulge or projection 310 formed in the mold. In still another embodiment, both the heel section 316a and the lip section 316b are formed by molding them in a single mold bonding them together by a curing process.

To improve the life of the piston seal 316, both the heel section 316a and the lip section 316b can be made of an elastomer, such as a thermoset polyurethane available from Air-Products, Inc., among other suppliers. In one embodiment the heel section 316a is made of an elastomer with a hardness of between Shore D 60 and Shore D 70 Durometer, such as Anderson 2-60DP, Anderson 5-DPLM, Air-Products PET-60D Airthane, Air-Products D-6 Versathane, and Uniroyal LF-650D. The lip section 316b is made of an elastomer with a hardness of Shore A 85 Durometer, such as Air-Products 85A Airthane, Air-Products 85A Versathane, Anderson 9-AP-LM, Anderson 80-%AP, and Uniroyal 1860 LM. A hardness of Shore D 65 Durometer is greater than a hardness of Shore A 85 Durometer. The heel and lip sections are bonded together using a bonding agent such as Lord Corporation's CHEMLOCK 213 or CHEMLOCK 218. Other hardnesses, resilient materials, and bonding agents can also be used.

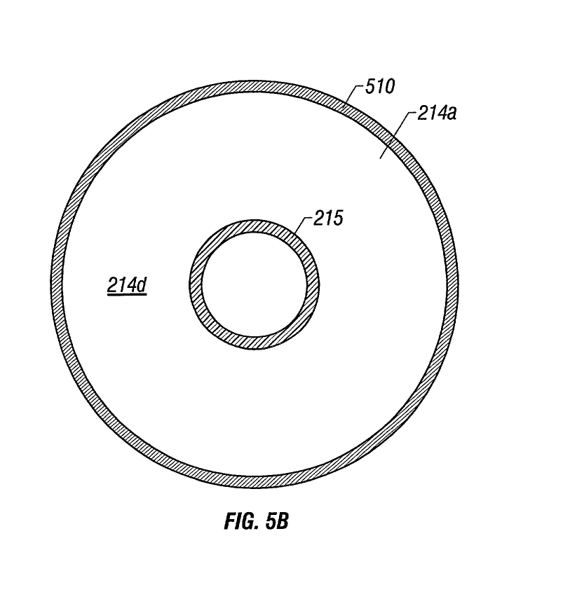

In one embodiment, as shown in FIG. 4 the heel section 316b has a diameter larger than the diameter of the flange 214a, and extends externally along the outer surface of the flange 214a, covering an outer surface of the flange 214a with a covering 316c of the same material as the heel section 316a, providing additional protection against damage to the cylinder 210.

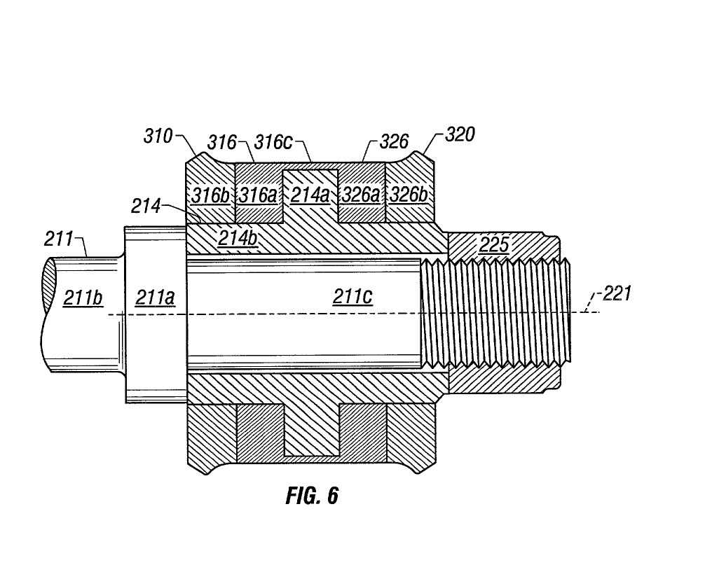

In a further embodiment, the flange 214a is formed as shown in FIG. 5. FIG. 5a shows a cross-sectional view of this embodiment. The flange 214a as shown in FIG. 5a has an annular lip 520 in the surface 214d. The resilient material of heel section 316a is then wrapped around the outer surface of the flange 214a in an overlap 510 on the annular lip 520, providing an improved bonding surface for bonding the heel section 316 to the piston hub 214. FIG. 5b shows an end view of the embodiment of FIG. 5a showing the overlap 510.

As shown in FIGS. 3-5, the piston seal 316 is bonded to the piston hub 214, eliminating the need for the retaining ring 220 and snap ring 222, as well as the annular groove 214e of FIG. 2. However, in a disclosed embodiment, the piston seal 316 of FIG. 3-5 can be constructed without bonding the piston seal 316 to the piston hub 214, allowing replacement of the piston seal 316 onto the piston hub 214. In such an embodiment, retaining ring 220, snap ring 222, and annular groove 214e can be used to retain the piston seal 316 on the piston hub 214. In a further embodiment, other techniques for fastening the piston seal 316 removably to the piston hub 214 can be used. Depending on the fastening technique, an upper surface 316d of the piston seal may be formed in various manners to accommodate fasteners or other parts to fasten the piston seal onto the piston hub.

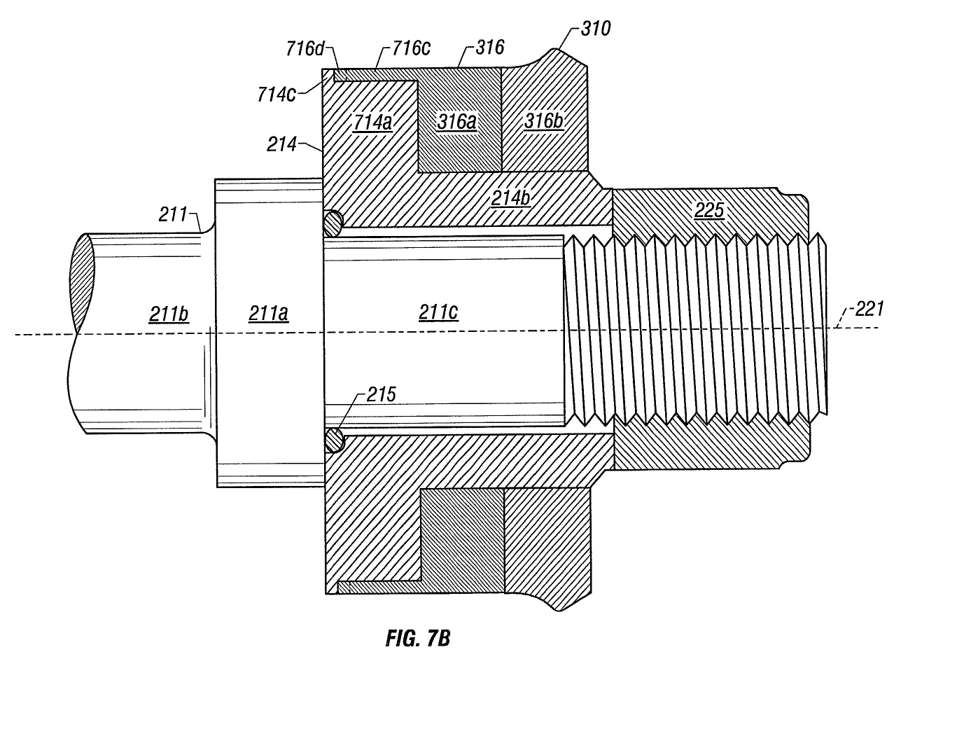

FIGS. 7a and 7b illustrate a fourth embodiment of a piston seal 316 mounted on a cylinder. FIG. 7a shows the covering 716c extending externally along an outer surface of the flange 714a, corresponding to the flange 214a of FIGS. 3-5. Unlike the embodiments of FIGS. 3-5, however, covering 716c does not extend across the entire outer surface of the flange 614a, but covers a smaller portion of the outer surface. In higher pressure environments, pressure deformation of the resilient material can increase wear on the piston seal 316. Although normal operating pressure of a pump 100 ranges from approximately 2500 PSI to approximately 4000 PSI, high-pressure pumps can exceed 4000 PSI. An uncovered portion 714c can provide additional strength for higher-pressure environments, resisting extrusion of the resilient material past the flange 714a under pressure. FIGS. 7a and 7b show two alternate shapes for the uncovered portion 714c and corresponding shapes of an end portion 716d of the covering 716c. Other shapes than shown in FIGS. 7a-7b can be used. The uncovered portion 714d is preferably 1/16″ to 3/16″ thick, but other thicknesses can be used.

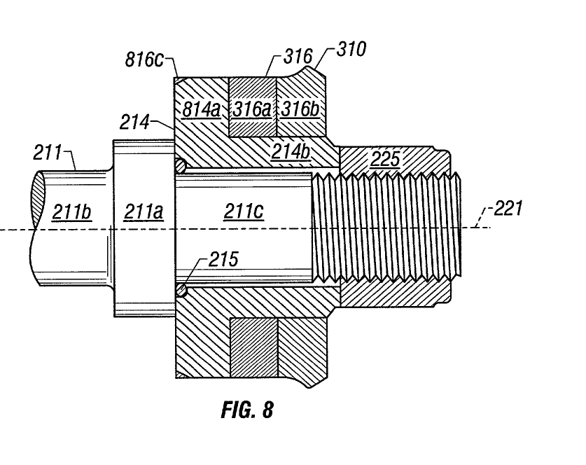

FIG. 8 illustrates a fifth embodiment of a piston seal 316. In FIG. 8, an annular bumper section 816c is inserted at the intersection of an outer surface and a posterior surface of the flange 814a, providing additional wear minimization by eliminating some of the metal-to-metal contact between the flange 814a and the cylinder lines. Although as shown in FIG. 8 the bumper section 816c is shown as generally triangular, other shapes can be used.

FIGS. 3-5, and 7-8 illustrate techniques for minimizing metal-to-metal contact within the pump 100. Combinations of the embodiments of FIGS. 7-8 can be used, further minimizing the amount of the outer surface of the flange 214 not covered by the resilient material. By minimizing the potential for metal-to-metal contact, wear in the pump 100 can be reduced, increasing the life of the piston seal 214.

The disclosed technique reduces wear on the inside wall 148a, piston head 146, and other parts of the pump 100 caused by progressive degradation of the piston seal 146b of conventional pumps. The stress point 230 of the conventional piston seal 216 of FIG. 2 is moved in the disclosed technique to a stress point 330 at the annular bulge or projection 310 of FIGS. 3-5, 7a, 7b, and 8. As noted above, because the annular bulge 310 is compressible, wear on the annular bulge 310 will not destroy the seal and reduces misalignment within the piston 145. Further, by covering the outer surface of the piston flange 214a, metal-to-metal contact between the cylinder 210 and the piston flange 214a is prevented, additionally reducing wear on the cylinder 210.

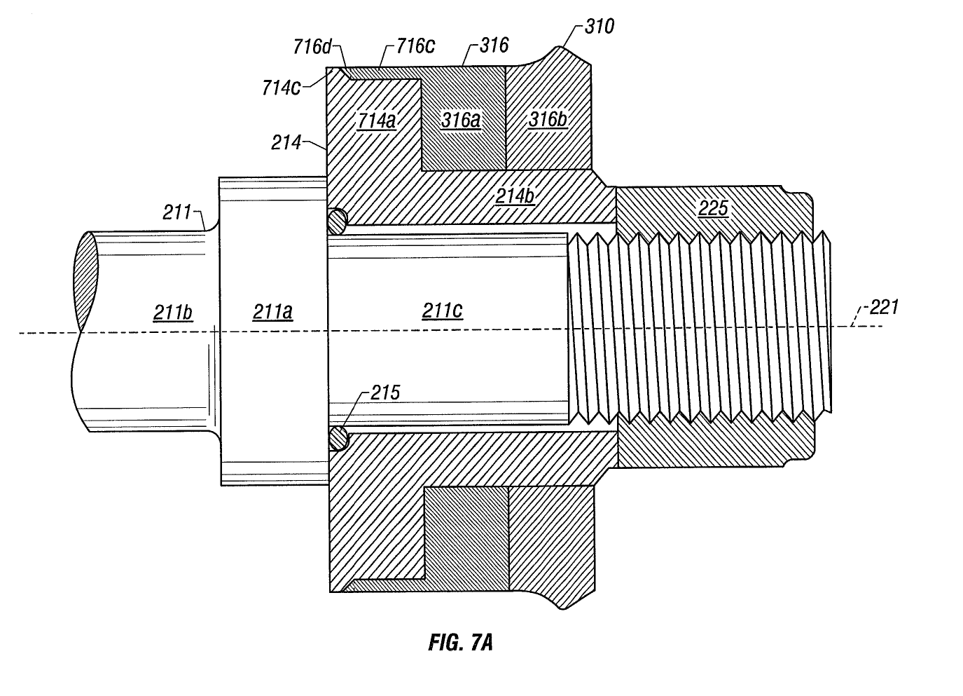

Although the above has been described in terms of a simplex piston head, the disclosed technique can be used with a duplex piston head having two piston seals 316 and 326 on both sides of the duplex piston head. In a duplex piston head embodiment shown in FIG. 6, the flange 214a is embedded between the two piston seals 316 and 326, with an annular middle section 316c connecting the two piston seals 316 and 326 made of the resilient material of heel sections 316b and 326b and covering the outer surface of the flange 214a. As with the simplex piston head assemblies of FIGS. 3-5, the duplex piston head as shown in FIG. 6 is retained on the piston rod 211 by means of a retainer nut 225. Other duplex piston rod and piston head configurations and attachment methods can be used, such as a the use of an internally tapered bore of the piston hub 214 which mates with an externally tapered piston rod 211.

Because less wear occurs within piston 145, the disclosed technique allows longer run times between maintenance outages. This increases the productivity of reciprocating pump 100, as there is less downtime for maintenance and repairs. Further, actual maintenance and repair costs are reduced, such as labor costs and component costs. Although pump 100 has been illustrated in conjunction with the detailed description of the present invention, a reciprocating compressor according to the present invention is also contemplated, as are other embodiments of reciprocating pumps and compressors. For example, the piston head can be reciprocated by a hydraulic cylinder.

The foregoing disclosure and description of the invention are illustrative and explanatory thereof, and various changes in the details of the illustrated apparatus and construction and method of operation may be made without departing from the spirit of the invention.

Although the invention is described with particular reference to a pump piston used with slush or mud pumps, it will be recognized that certain features thereof may be used or adapted for use in other types of reciprocating pumps. Likewise it will be understood that various modifications can be made to the present seal without departing from the spirit of the invention. For example, the relative dimensions of various parts, the materials from which the seal is made, and other parameters can be varied.

We claim:

1. A piston head assembly for reciprocating in a cylinder, the cylinder having an inside surface, the inside surface having an inside diameter, the piston head assembly comprising:
a piston hub comprising:
an annular flange having an outer surface; and
an annular resilient piston seal mounted on the piston hub, the annular resilient piston seal comprising:
an annular heel section of a first resilient material having a first hardness, the annular flange concentrically embedded into a posterior portion of the annular heel section, an outer portion of the posterior portion of the annular heel section surrounding a portion of the outer surface of the annular flange.

2. The piston head assembly of claim 1, wherein the annular resilient piston seal is bonded to the piston hub.

3. The piston head assembly of claim 1, wherein the annular heel section surrounds the entire outer surface of the annular flange.

4. The piston head assembly of claim 3, the annular flange comprising:
an annular lip on a posterior surface of the annular flange, the heel section overlapping the annular lip.

5. The piston head assembly of claim 1, the annular resilient piston seal further comprising:
a lip section of a second resilient material, the second resilient material having a second hardness with the second hardness being less than the first hardness, the lip section concentrically connected to the annular heel section, the lip section comprising:
an annular projection formed in an outer surface of the lip section, the annular projection having a maximum outer diameter in an interior portion of the annular projection greater than the inside diameter of the inner surface of the cylinder, the annular projection compressible upon insertion of the piston head assembly into the cylinder, forming a seal.

6. The piston head assembly of claim 5, the annular projection formed by machining the second resilient material.

7. The piston head assembly of claim 5, the annular projection formed by molding the second resilient material.

8. The piston head assembly of claim 5, wherein the annular projection has a generally triangular cross section.

9. The piston head assembly of claim 5, wherein the second resilient material is a polyurethane.

10. The piston head assembly of claim 1, wherein the first resilient material is a polyurethane.

11. A resilient annular piston seal for mounting on a piston head for reciprocating in a cylinder, the cylinder having an inside surface, the inside surface having an inside diameter, the resilient annular piston seal comprising:
an annular flange having an outer surface,
an annular heel section of a first resilient material having a first hardness, the annular flange concentrically embedded into a posterior portion of the annular heel section, an outer portion of the posterior portion of the annular heel section surrounding a portion of the outer surface of the annular flange.

12. The piston seal of claim 11, wherein the piston seal is bonded to the annular flange.

13. The piston seal of claim 11, wherein the annular heel section surrounds the entire outer surface of the annular flange.

14. The piston seal of claim 13, the annular flange comprising:
an annular lip on a posterior surface of the annular flange, the annular heel section overlapping the annular lip.

15. The piston seal of claim 11, the annular resilient piston seal further comprising:
a lip section of a second resilient material, the second resilient material having a second hardness with the second hardness being less than the first hardness, the lip section concentrically connected to the annular heel section, the lip section comprising:
an annular projection formed in an outer surface of the lip section, the annular projection having a maximum outer diameter in an interior portion of the annular projection greater than the inside diameter of the inner surface of the cylinder, the annular projection compressible upon insertion of the piston head assembly into the cylinder, forming a seal.

16. The piston seal of claim 15, the annular projection formed by machining the second resilient material.

17. The piston seal of claim 15, the annular projection formed by molding the second resilient material.

18. The piston seal of claim 15, wherein the annular projection has a generally triangular cross section.

19. The piston seal of claim 15, wherein the second resilient material is a polyurethane.

20. The piston seal of claim 11, wherein the first resilient material is a polyurethane.

21. A method of sealing a piston head for reciprocating in a cylinder, the cylinder having an inside surface, the inside surface having an inside diameter, the method comprising the steps of:
forming an annular heel section from a first resilient material having a first hardness;
concentrically embedding an annular flange in a posterior portion of the annular heel section, covering a portion of the outer surface of the annular flange with the first resilient material;
attaching the annular heel section to the annular flange, forming a piston head; and
inserting the piston head into the cylinder.

22. The method of claim 21, the step of attaching the annular heel section to the annular flange comprising the step of:
bonding the annular heel section to the annular flange.

23. The method of claim 21, the step of concentrically embedding an annular flange in a posterior portion of the annular heel section comprising the step of:
covering the entire outer surface of the annular flange with the annular heel section.

24. The method of claim 23, further comprising the step of:
concentrically forming an annular lip in a posterior surface of the annular flange; and
the step of embedding the annular flange comprising the step of:
wrapping the annular heel section around the outer surface of the annular flange onto the annular lip of the annular flange.

25. The method of claim 21, further comprising the step of:
concentrically forming an annular lip section from a second resilient material having a second hardness onto an anterior surface of the annular heel section, with the second hardness being less than the first hardness, the annular lip section having a maximum outer diameter in an interior portion of the annular lip section larger than the inside diameter of the inside surface; and
the step of inserting the piston head into the cylinder comprising the step of:
radially compressing the annular lip section to form a seal.

26. The method of claim 24, the step of concentrically forming an annular lip section comprising the step of:
forming an annular projection on an outer surface of the lip section, the annular projection having a maximum outer diameter in an interior portion of the annular projection equal to the maximum outer diameter of the lip section.

27. The method of claim 25, wherein the second resilient material is a polyurethane.

28. The method of claim 24, wherein the first resilient material is a polyurethane.

29. A method of improving the life of a reciprocating piston seal in a cylinder, the cylinder having an inside surface, the inside surface having an inside diameter, the method comprising the steps of:
forming a resilient annular piston seal from a resilient material onto an annular piston hub having an anterior surface, a posterior surface, and an outer surface, the resilient annular piston seal formed onto the anterior surface of the piston hub, the resilient annular piston seal generally having an outer diameter less than the inside diameter of the cylinder; and
forming the resilient material around a portion of the outer surface of the piston hub, covering the portion of the outer surface of the piston hub.

30. The method of claim 29, the step of forming the resilient material around the portion of the outer surface of the piston hub comprising the step of:
bonding the resilient annular piston seal to the piston hub.

31. The method of claim 29, the step of forming the resilient material around the portion of the outer surface of the piston hub comprising the steps of:
forming a annular lip in the posterior surface of the piston hub; and
wrapping the resilient material over the annular lip.

32. The method of claim 29, the step of forming a resilient annular piston seal comprising the steps of:
forming a heel portion of a first resilient material having a first hardness.

33. The method of claim 32, the step of forming a resilient annular piston seal further comprising the step of:
concentrically forming a lip portion of a second resilient material having a second hardness onto the heel portion distal from the piston hub, with the second hardness being less than the first hardness; and
forming a concentric annular projection in the lip portion having a maximum outer diameter in an interior portion of the concentric annular projection greater than the inside diameter of the cylinder.

34. The method of claim 33, wherein the concentric annular projection has a generally triangular cross-section.

35. A piston head assembly for reciprocating in a cylinder, the cylinder having an inside surface, the inside surface having an inside diameter, the piston head assembly comprising:
a piston hub comprising:
an annular flange having a first surface, a second surface, and an outer surface connecting the first surface and the second surface; and
a first annular resilient piston seal mounted on the first surface of the piston hub, the first annular resilient piston seal comprising:
a first annular heel section of a first resilient material having a first hardness;
a second annular resilient piston seal mounted on the second surface of the piston hub, the second annular resilient piston comprising:
a second annular heel section of the first resilient material; and
an annular middle section of the first resilient material connecting the first annular resilient piston seal and the second annular resilient piston seal, the annular middle section covering the outer surface of the annular flange.

36. A piston head assembly for reciprocating in a cylinder, the cylinder having an inside surface, the inside surface having an inside diameter, the piston head assembly comprising:
a piston hub comprising:
an annular flange having an anterior surface, an outer surface and a posterior surface; and
an annular resilient piston seal mounted on the piston hub, the annular resilient piston seal comprising:
an annular heel section of a first resilient material having a first hardness mounted on the anterior surface of the annular flange; and
an annular bumper section of the first resilient material covering the outer surface of the annular flange at an intersection between the outer surface and the posterior surface.

37. The piston head assembly of claim 36, the annular resilient piston seal further comprising:
a lip section of a second resilient material, the second resilient material having a second hardness with the second hardness being less than the first hardness, the lip section concentrically connected to the annular heel section, the lip section comprising:
an annular projection formed in an outer surface of the lip section, the annular projection having a maximum outer diameter in an interior portion of the annular projection greater than the inside diameter of the inner surface of the cylinder, the annular projection compressible upon insertion of the piston head assembly into the cylinder, forming a seal.

38. The piston head assembly of claim 37, wherein the annular projection has a generally triangular cross section.

39. The piston head assembly of claim 37, wherein the second resilient material is a polyurethane.

40. The piston head assembly of claim 35, wherein the first resilient material is a polyurethane.
